(19) United States
(12) Patent Application Publication
(10) Pub. No.: US 2025/0293580 A1
(43) Pub. Date: Sep. 18, 2025

(54) ELECTRIFIED VEHICLE AND METHOD OF CONTROLLING SAME

(71) Applicants: Hyundai Motor Company, Seoul (KR); Kia Corporation, Seoul (KR)

(72) Inventors: Jee Heon Kim, Suwon-si (KR); Jae Hyun Kim, Osan-si (KR); Sun Ho Lee, Uiwang-si (KR); Gyu Tae Choi, Suwon-si (KR); Young Jae Lee, Uiwang-si (KR)

(21) Appl. No.: 18/797,735

(22) Filed: Aug. 8, 2024

(30) Foreign Application Priority Data
Mar. 18, 2024 (KR) 10-2024-0037343

(51) Int. Cl. H02M 1/00; B60L 55/00

(52) U.S. Cl. CPC H02M 1/0043; B60L 55/00

(57) ABSTRACT

An embodiment electrified vehicle includes a power conversion device configured to perform power conversion between a direct current (DC) voltage and an alternating current (AC) voltage through a switching operation according to a duty and a controller configured to determine a first phase value at which a sign of an alternating current according to the AC voltage changes based on a phase of the AC voltage during a unit cycle and to perform duty compensation during a duty compensation period determined based on the first phase value.

### CROSS-REFERENCE TO RELATED APPLICATIONS

This application claims the benefit of Korean Patent Application No. 10-2024-0037343, filed on Mar. 18, 2024, which application is hereby incorporated herein by reference.

### TECHNICAL FIELD

The present disclosure relates to an electrified vehicle and a method of controlling the same.

### BACKGROUND

Recently, as interest in the environment has increased, the number of eco-friendly vehicles equipped with electric motors as a power source is increasing. Eco-friendly vehicles are also called electrified vehicles, and representative examples include a hybrid electric vehicle (HEV) and an electric vehicle (EV).

With the spread of vehicles using electricity as a power source, the demand for electricity increases rapidly, and the development of technology to solve this problem is required.

In addition, as a means of meeting electricity demand, attempts to utilize new and renewable energy such as wind power and solar power generation are increasing due to the trend toward eco-friendliness to minimize environmental pollution. However, in the case of new and renewable energy, the supply is unstable, and thus an energy storage device that can balance supply and demand is required.

A battery of an electric vehicle having an electric motor as a driving source can serve as an energy storage device. In order for an electric vehicle to perform this function, vehicle to grid (V2G) technology that allows power stored in the vehicle battery to be supplied to a power grid needs to be realized. Unlike the existing on-board charger (OBC), V2G is a concept of transmitting energy stored in a battery back to the power grid by connecting a rechargeable eco-friendly vehicle such as an electric vehicle to the power grid through a bidirectional OBC capable of not only receiving power from the power grid but also supplying power of vehicles to the power grid. In this case, a vehicle functions as an energy storage system (ESS).

### SUMMARY

The present disclosure relates to an electrified vehicle and a method of controlling the same. Particular embodiments relate to an electrified vehicle and a method of controlling the same which can improve harmonic distortion due to a dead time in the process of supplying power from a vehicle to a grid.

Therefore, embodiments of the present disclosure take into consideration problems in the art, and exemplary embodiments of the present disclosure improve harmonic distortion caused by a dead time by compensating for a duty for power conversion according to reactive power and active power required by a grid in a process of supplying power from a vehicle to the grid.

The embodiments of the present disclosure are not limited to the aforementioned embodiment, and other embodiments that are not mentioned will be clearly understood by those skilled in the art from the description below.

In accordance with an embodiment of the present disclosure, the above and other embodiments can be accomplished by the provision of an electrified vehicle including a power conversion device configured to perform power conversion between a direct current (DC) voltage and an alternating current (AC) voltage through a switching operation according to a duty and a controller configured to determine a first phase value at which a sign of an alternating current according to the AC voltage changes based on a phase of the AC voltage during a unit cycle and to perform duty compensation during a duty compensation period determined based on the first phase value.

For example, the power conversion device may be connected to a grid and a battery, and the controller may perform the duty compensation while a DC voltage of the battery is converted into the AC voltage through the power conversion device and supplied to the grid.

For example, the controller may include a phase locked loop having the AC voltage as an input signal and may determine the phase of the AC voltage based on an output signal of the phase locked loop.

For example, the controller may determine the first phase value by applying a delay/lag phase value of the alternating current with respect to the phase of the AC voltage to a second phase value at which a sign of the AC voltage changes.

For example, the power conversion device may perform the power conversion based on an active power command and a reactive power command from the grid, and the delay/lag phase value may be determined based on the active power command and the reactive power command.

For example, the duty compensation period may be a period other than a first range based on the first phase value in a phase of the alternating current during the unit cycle.

For example, the first range may be determined in consideration of the AC voltage and a present duty of the power conversion device.

For example, the size of the first range may be proportional to the AC voltage and the present duty.

For example, the controller may maintain the present duty of the power conversion device during the first range.

For example, the controller may perform the duty compensation by applying a compensation duty determined based on a dead time and a switching frequency of the switching operation to the present duty of the power conversion device according to a current sign of the alternating current.

In accordance with another embodiment of the present disclosure, there is provided a method of controlling an electrified vehicle including performing, by a power conversion device, power conversion between a DC voltage and an AC voltage through a switching operation according to a duty, determining a first phase value at which a sign of an alternating current according to the AC voltage changes based on a phase of the AC voltage during a unit cycle, and performing duty compensation during a duty compensation period determined based on the first phase value.

For example, the performing duty compensation may be performed while a DC voltage of a battery is converted into the AC voltage through the power conversion device connected to a grid and the battery and supplied to the grid.

For example, the determining a first phase value may include determining the phase of the AC voltage based on an output signal of a phase locked loop having the AC voltage as an input signal.

For example, the determining a first phase value may include determining the first phase value by applying a delay/lag phase value of the alternating current with respect to the phase of the AC voltage to a second phase value at which a sign of the AC voltage changes.

For example, the power conversion device may perform the power conversion based on an active power command and a reactive power command from the grid, and the delay/lag phase value may be determined based on the active power command and the reactive power command.

For example, the duty compensation period may be a period other than a first range based on the first phase value in a phase of the alternating current during the unit cycle.

For example, the first range may be determined in consideration of the AC voltage and a present duty of the power conversion device.

For example, the size of the first range may be proportional to the AC voltage and the present duty.

For example, the method may further include maintaining the present duty of the power conversion device during the first range.

For example, the performing the duty compensation may include performing the duty compensation by applying a compensation duty determined based on a dead time and a switching frequency of the switching operation to the present duty of the power conversion device according to a current sign of the alternating current.

### BRIEF DESCRIPTION OF THE DRAWINGS

The above and other objects, features, and other advantages of embodiments of the present disclosure will be more clearly understood from the following detailed description taken in conjunction with the accompanying drawings, in which:

FIG. 1 is a diagram for describing a configuration of an electrified vehicle according to an embodiment of the present disclosure;

FIG. 2 is a diagram for describing a duty compensation process performed by a controller of the electrified vehicle according to an embodiment of the present disclosure; and

FIG. 3 is a diagram for describing a method of controlling the electrified vehicle according to an embodiment of the present disclosure.

### DETAILED DESCRIPTION OF ILLUSTRATIVE EMBODIMENTS

Specific structural and functional descriptions of the embodiments of the present disclosure, disclosed in the present specification or application, are merely illustrative for the purpose of explaining the embodiments according to the present disclosure, and the embodiments according to the present disclosure may be implemented in various forms and should not be construed as being limited to the embodiments described in this specification or application.

Since the embodiments according to the present disclosure can be modified in various manners and have various forms, specific embodiments will be illustrated in the drawings and described in detail in the specification or application. However, this is not intended to limit the embodiments according to the concept of the present disclosure to a specific disclosed form and should be understood to include all changes, equivalents, and substitutes included in the spirit and technical scope of the present disclosure.

All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification will be described in detail with reference to the attached drawings. However, identical or similar components will be assigned the same reference numeral, and redundant descriptions thereof will be omitted.

In the description of the following embodiments, the term “preset” means that the value of a parameter is predetermined when the parameter is used in a process or an algorithm. Depending on embodiments, the value of a parameter may be set when a process or an algorithm starts or may be set during a period in which the process or the algorithm is performed.

In the following description of the embodiments disclosed in the present specification, a detailed description of known functions and configurations incorporated herein will be omitted when it may obscure the subject matter of the present disclosure. In addition, the accompanying drawings are provided only for ease of understanding of the embodiments disclosed in the present specification, do not limit the technical spirit disclosed herein, and include all changes, equivalents, and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, a unit or a control unit included in names such as a motor control unit (MCU) and a hybrid control unit (HCU) is merely a term widely used in naming a control device that controls specific vehicle functions and does not mean a generic functional unit.

A controller may include a communication device that communicates with other controllers or sensors to control the functions of the controller, a memory that stores an operating system, logic instructions, input/output information, etc., and one or more processors that perform determination, computation, and decisions necessary to control the functions.

An electrified vehicle and a method of controlling the same according to an embodiment of the present disclosure compensate for a duty for power conversion according to reactive power and active power required by a grid in a process of supplying power from a vehicle to the grid (vehicle to grid (V2G)), and accordingly improve harmonic distortion caused by a dead time while satisfying ranges of active power and reactive power required by the grid.

In a process in which a power conversion device performs a switching operation to convert power, a plurality of switching elements used in the switching operation is complementarily turned on. In this case, if the switching elements having a complementary relationship are simultaneously turned on, the elements may be damaged. Accordingly, a dead time is applied to prevent elements from being damaged when they are simultaneously turned on by providing a slight time difference between turning on of the switching elements.

Meanwhile, when a dead time is applied, an error occurs between a command voltage and an output voltage, and as a result, the fundamental wave voltage decreases in the output voltage, which may increase total harmonic distortion. Therefore, an embodiment of the present disclosure improves total harmonic distortion caused by a dead time through duty compensation to meet power specifications required by the grid.

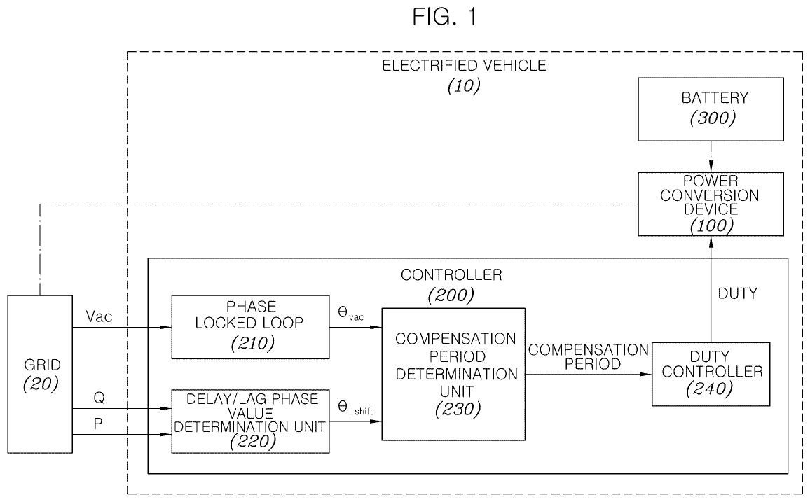

Hereinafter, a configuration of an electrified vehicle according to an embodiment of the present disclosure will be described first with reference to FIG. 1.

FIG. 1 is a diagram for describing the configuration of the electrified vehicle according to an embodiment of the present disclosure.

Referring to FIG. 1, an electrified vehicle 10 according to an embodiment of the present disclosure may include a power conversion device 100, a controller 200, and a battery 300, and it may be connected to a grid 20. However, FIG. 1 shows components related to description of an embodiment, and an actual electrified vehicle may be implemented by including more or fewer components.

First, the power conversion device 100 may be connected between the battery 300 and the grid 20 and may perform power conversion between a DC voltage and an AC voltage through a switching operation according to a duty. For example, the power conversion device 100 may charge the battery 300 by converting AC power from the grid 20 into a DC voltage and transmitting the DC voltage to the battery 300. Further, the power conversion device 100 may convert a DC voltage into AC power and provide the AC power to the grid 20. That is, in one embodiment, the power conversion device 100 may perform a V2G function.

To this end, the power conversion device 100 may include an inverter that performs conversion between an AC voltage and a DC voltage through the switching operation of a switching element and a bidirectional DC-DC converter that boosts or steps down the DC voltage.

The controller 200 controls the power conversion device 100, and in particular, may compensate for a duty that determines the switching operation of the power conversion device 100 in an embodiment of the present disclosure.

More specifically, based on the phase during a unit cycle of the AC voltage applied to the power conversion device 100, the controller 200 may determine a first phase value at which the sign of the alternating current according to the AC voltage changes. Thereafter, the controller 200 may determine a duty compensation period based on the determined first phase value and perform duty compensation during the duty compensation period.

In this case, the controller 200 may perform duty compensation while converting the DC voltage of the battery 300 into an AC voltage and supplying the AC voltage to the grid 20 through the power conversion device 100. That is, duty compensation of the power conversion device 100 through the controller 200 may be performed during V2G operation. At the time of supplying power to the grid 20, specifications with respect to the ranges of active power and reactive power and total harmonic distortion may need to be met. It is possible to meet power specifications required for power supplied to the grid 20 through duty compensation during the V2G operation.

In order to perform such duty compensation, the controller 200 may include a phase locked loop 210, a delay/lag phase value determination unit 220, a compensation period determination unit 230, and a duty controller 240.

First, before performing duty compensation, the controller 200 determines a duty compensation period in which a duty will be compensated. To this end, the controller 200 may determine the phase θ_{Vac} of an AC voltage based on the output signal of the phase locked loop 210 having the AC voltage Vac as an input signal. This phase locked loop 210 may acquire the AC voltage Vac from the grid 20 as an input signal and then output the phase θ_{Vac} corresponding to the input AC voltage Vac through processes such as d and q conversion, proportional-integral (PI) control, and voltage range limitation.

The delay/lag phase value determination unit 220 determines a delay/lag phase value of the alternating current with respect to the phase of the AC voltage and may obtain a reactive power command Q and an active power command P of the grid 20 for this purpose. For example, the delay/lag phase value θ_{Ishift} may be determined using the following Equation 1.

$${tan}^{- 1} \frac{Q}{P} = {θ}_{Ishift} \qquad Equation 1$$

In this case, the reactive power command Q and the active power command P of the grid 20 may be transmitted to the delay/lag phase value determination unit 220 through a vehicle charging management system (VCMS). Such a vehicle charging management system may be provided on the side of the electrified vehicle 10, or it may be provided in a charger that connects the grid 20 and the electrified vehicle 10.

The power conversion device 100 performs power conversion based on the active power command P and the reactive power command Q from the grid 20, and the delay/lag phase value determination unit 220 may determine the delay/lag phase value θ_{Ishift} of the alternating current with respect to the phase of the AC voltage based on the active power command P and the reactive power command Q.

The compensation period determination unit 230 may determine the first phase value at which the sign of the alternating current according to the AC voltage changes based on the phase θ_{Vac} during the unit cycle of the AC voltage, which is the output signal of the phase locked loop 210, and determine a duty compensation period based on the determined first phase value.

More specifically, the compensation period determination unit 230 may first determine a second phase value at which the sign of the AC voltage changes from the phase θ_{Vac} during the unit cycle of the AC voltage, which is the output signal of the phase locked loop 210, and determine the first phase value at which the sign of the alternating current changes by applying the delay/lag phase value θ_{Ishift} determined by the delay/lag phase value determination unit 220 to the second phase value.

That is, the first phase value may mean a zero crossing point where the value of the alternating current is “0”, and the second phase value may mean a zero crossing point where the value of the AC voltage is “0”. Accordingly, determining a compensation period based on the first phase value and the second phase value may be understood as detecting the zero crossing point of AC power from the zero crossing point of the AC voltage and determining the compensation period based on the zero crossing point of the AC power.

When the first phase value is determined, the compensation period determination unit 230 may determine a first range based on the determined first phase value and determine a period excluding the first range during the unit cycle as the duty compensation period. Here, the first range is a period including a period where the value of the alternating current is “0”. This period is a period in which the fundamental wave voltage does not decrease compared to the command voltage due to a dead time, and thus the period is excluded from the duty compensation period.

In this case, the first range may be determined in consideration of the AC voltage Vac and the present duty of the power conversion device 100. More specifically, the first range may be based on the first phase value, and the size thereof may be determined to be proportional to the AC voltage Vac and the present duty.

When the compensation period is determined, the duty controller 240 may transmit the final duty obtained by applying a compensation duty to the present duty during the compensation period to the power conversion device 100 and control the power conversion device 100 to perform power conversion according to the final duty.

In this case, the compensation duty may be determined based on a dead time and a switching frequency of the switching operation. For example, the product of the dead time and the switching frequency may be determined as the compensation duty. Additionally, the duty controller 240 may apply the compensation duty to the present duty according to the current sign of the alternating current. For example, the duty controller 240 may perform duty compensation by adding the compensation duty to the present duty when the current sign of the alternating current is (+) and by subtracting the compensation duty from the present duty when the current sign of the alternating current is (−).

Meanwhile, the duty controller 240 may maintain the present duty of the power conversion device 100 without performing duty compensation in the first range that does not correspond to the duty compensation period. In this case, the present duty is used as the final duty to determine the switching operation of the power conversion device 100.

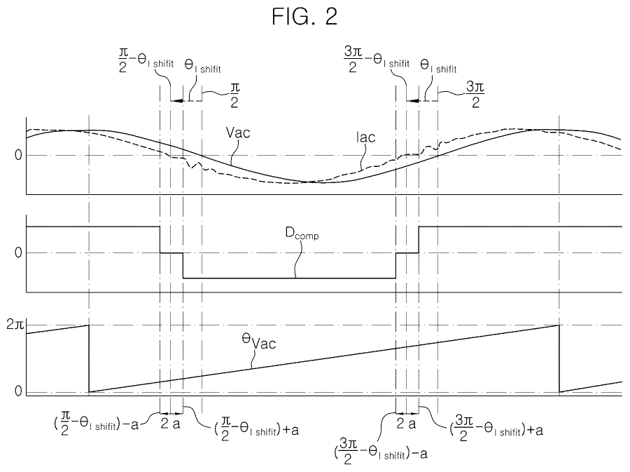

Hereinafter, the duty compensation process will be described in more detail with reference to FIG. 2.

FIG. 2 is a diagram for describing the duty compensation process performed by the controller of the electrified vehicle according to an embodiment of the present disclosure.

FIG. 2 is a graph showing the behaviors of the AC voltage Vac and the alternating current Iac and the compensation duty D_{comp} while the unit cycle 2 π is repeated.

First, the controller 200 determines second phase values π/2 and 3 π/2 at which the sign of the AC voltage Vac changes based on the phase θ_{vac} of the AC voltage Vac determined based on the AC voltage Vac of the grid 20. Then, the controller 200 determines first phase values π/2−θ_{Ishift} and 3 π/2−θ_{Ishift} at which the sign of the alternating current changes from the determined second phase values π/2 and 3 π/2 by applying the delay/lag phase value θ_{Ishift} to the determined second phase values π/2 and 3 π/2.

The determined first phase values π/2−θ_{Ishift} and 3 π/2−θ_{Ishift} serve as criteria for the duty compensation period. More specifically, the controller 200 may determine the first range (π/2−θ_{Ishift})−α to (π/2−θ_{Ishift})+α and (31/2−θ_{Ishift})−α to (3 π/2−θ_{Ishift})+α based on the first phase values (π/2−θ_{Ishift} and 3 π/2−θ_{Ishift}, and determine a period other than the first range (π/2−θ_{Ishift})−α to (π/2−θ_{Ishift})+α and (3 π/2−θ_{Ishift})−α to (3 π/2−θ_{Ishift})+α as the duty compensation period.

In this case, the size 2α of the first range may be proportional to the magnitude of the AC voltage Vac and the present duty, and it may be determined, for example, by the following Equation 2.

$$α = β * Vac * Duty \qquad Equation 2$$

Here, α is a factor that determines the size of the first range, Vac is the magnitude of the AC voltage, Duty represents the present duty, and β represents a proportional constant for the AC voltage and the present duty.

When the compensation period is determined as above, the controller 200 performs duty compensation by reflecting the compensation duty D_{comp} in the present duty according to the current sign of the alternating current during the compensation period. Accordingly, the compensation duty D_{comp} may have a positive value in the period in which the sign of the alternating current is (+) and may have a negative value in the period in which the sign of the alternating current is (−). Additionally, since duty compensation is not performed in the first range that does not correspond to the compensation period, the compensation duty D_{comp} may have a value of “0” in the first range.

Hereinafter, a method of controlling the electrified vehicle according to an embodiment will be described using a flowchart.

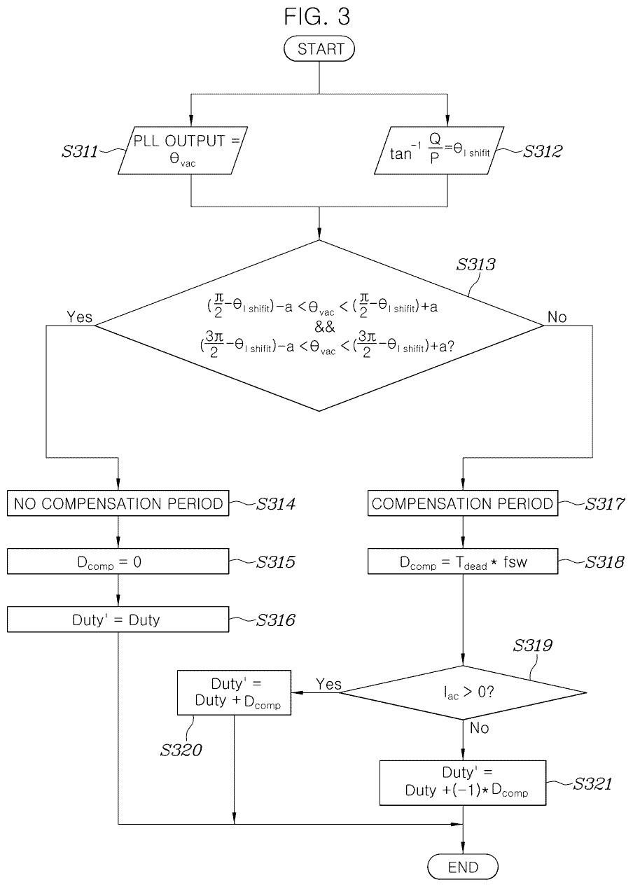

FIG. 3 is a diagram for describing the method of controlling the electrified vehicle according to an embodiment of the present disclosure.

Referring to FIG. 3, first, the controller 200 may acquire the phase θ_{vac} of the AC voltage through the output of the phase locked loop 210 (S311) and obtain the delay/lag phase value θ_{Ishift} based on the active power command P and the reactive power command Q (S312).

The controller 200 may determine the first range (π/2−θ_{Ishift})−α to (π/2−θ_{Ishift})+α and (3 π/2−θ_{Ishift})−α to (3 π/2−θ_{Ishift})+α based on the obtained phase θ_{vac} of the AC voltage and the delay/lag phase value θ_{Ishift} and determine whether the phase θ_{vac} of the AC voltage is included in the first range (π/2−θ_{Ishift})−α to (π/2−θ_{Ishift})+α and (3 π/2−θ_{Ishift})−α to (3 π/2−θ_{Ishift})+α to determine whether to perform duty compensation (S313). For example, the controller 200 may determine that the first range is not a compensation period if the phase θ_{vac} of the AC voltage is included in the first range (π/2−θ_{Ishift})−α to (π/2−θ_{Ishift})+a and (3 π/2−θ_{Ishift})−α to (3 π/2−θ_{Ishift})+α (Yes in S313) and determine the first range corresponds to a compensation period if the phase θ_{vac} of the AC voltage is not included in the first range (π/2−θ_{Ishift})−α to (π/2−θ_{Ishift})+α and (3 π/2−θ_{Ishift})−α to (3 π/2−θ_{Ishift})+α (No in S313) (S317).

If it is determined that the first range is not a compensation period (S314), the controller 200 determines the compensation duty D_{comp} to be “0” (S315) and controls the power conversion device 100 using the present duty Duty as a final duty Duty′ (S316).

On the other hand, in the compensation period (S317), the controller 200 determines the compensation duty D_{comp} based on a dead time T_{dead} and a switching frequency fsw (S318) and performs duty compensation by reflecting the compensation duty D_{comp} in the present duty Duty according to the current sign of the alternating current I_{ac} (S319).

For example, the controller 200 may perform duty compensation by adding the compensation duty D_{comp} to the present duty Duty (S320) if the current sign of the alternating current I_{ac} is positive (Yes in S319) and perform duty compensation by subtracting the compensation duty D_{comp} from the present duty Duty (S321) if the current sign of the alternating current I_{ac} is negative (No in S319).

After duty compensation, the controller 200 controls the power conversion device 100 using the final duty Duty′ determined by duty compensation.

According to various embodiments of the present disclosure as described above, it is possible to improve harmonic distortion while satisfying ranges of reactive power and active power required by a grid through duty compensation of power conversion in the process of supplying power from a vehicle to the grid.

In addition, it is possible to secure the harmonic distortion improvement performance described above without additional hardware by compensating for a duty through a phase locked loop and to expand an applicable power factor range to improve robustness during application.

The effects that can be obtained from embodiments of the present disclosure are not limited to the effects mentioned above, and other effects that are not mentioned can be clearly understood by those skilled in the art from the description herein.

As is apparent from the above description, embodiments of the present disclosure provide an electrified vehicle and a method of controlling the same.

Although the preferred embodiments of the present disclosure have been disclosed for illustrative purposes, those skilled in the art will appreciate that various modifications, additions, and substitutions are possible, without departing from the scope and spirit of the disclosure as disclosed in the accompanying claims.

What is claimed is:

1. An electrified vehicle comprising:
a power conversion device configured to perform power conversion between a direct current (DC) voltage and an alternating current (AC) voltage through a switching operation according to a duty; and
a controller configured to determine a first phase value at which a sign of an alternating current according to the AC voltage changes based on a phase of the AC voltage during a unit cycle and to perform duty compensation during a duty compensation period determined based on the first phase value.

2. The electrified vehicle of claim 1, wherein the controller comprises a phase locked loop having the AC voltage as an input signal, and wherein the controller is configured to determine the phase of the AC voltage based on an output signal of the phase locked loop.

3. The electrified vehicle of claim 1, wherein the power conversion device is connected to a grid and a battery, and wherein the controller is configured to perform the duty compensation while a DC voltage of the battery is converted into the AC voltage through the power conversion device and supplied to the grid.

4. The electrified vehicle of claim 3, wherein the controller is configured to determine the first phase value by applying a delay/lag phase value of the alternating current with respect to the phase of the AC voltage to a second phase value at which a sign of the AC voltage changes.

5. The electrified vehicle of claim 4, wherein the power conversion device is configured to perform the power conversion based on an active power command and a reactive power command from the grid, and wherein the delay/lag phase value is determined based on the active power command and the reactive power command.

6. The electrified vehicle of claim 1, wherein the duty compensation period is a period other than a first range based on the first phase value in a phase of the alternating current during the unit cycle.

7. The electrified vehicle of claim 6, wherein the first range is determined in further consideration of the AC voltage and a present duty of the power conversion device.

8. The electrified vehicle of claim 7, wherein a size of the first range is proportional to the AC voltage and the present duty.

9. The electrified vehicle of claim 6, wherein the controller is configured to maintain a present duty of the power conversion device during the first range.

10. The electrified vehicle of claim 1, wherein the controller is configured to perform the duty compensation by applying a compensation duty determined based on a dead time and a switching frequency of the switching operation to a present duty of the power conversion device according to a current sign of the alternating current.

11. A method of controlling an electrified vehicle, the method comprising:
performing power conversion between a direct current (DC) voltage and an alternating current (AC) voltage through a switching operation according to a duty;
determining a first phase value at which a sign of an alternating current according to the AC voltage changes based on a phase of the AC voltage during a unit cycle; and
performing duty compensation during a duty compensation period determined based on the first phase value.

12. The method of claim 11, wherein determining the first phase value comprises determining the phase of the AC voltage based on an output signal of a phase locked loop having the AC voltage as an input signal.

13. The method of claim 11, wherein performing the duty compensation is performed while a DC voltage of a battery is converted into the AC voltage through a power conversion device connected to a grid and the battery and supplied to the grid.

14. The method of claim 13, wherein determining the first phase value comprises determining the first phase value by applying a delay/lag phase value of the alternating current with respect to the phase of the AC voltage to a second phase value at which a sign of the AC voltage changes.

15. The method of claim 14, wherein performing the power conversion comprises performing the power conversion based on an active power command and a reactive power command from the grid, and wherein the delay/lag phase value is determined based on the active power command and the reactive power command.

16. The method of claim 11, wherein the duty compensation period is a period other than a first range based on the first phase value in a phase of the alternating current during the unit cycle.

17. The method of claim 16, wherein the first range is determined in consideration of the AC voltage and a present duty of a power conversion device.

18. The method of claim 17, wherein a size of the first range is proportional to the AC voltage and the present duty.

19. The method of claim 16, further comprising maintaining a present duty of a power conversion device during the first range.

20. The method of claim 11, wherein performing the duty compensation comprises performing the duty compensation by applying a compensation duty determined based on a dead time and a switching frequency of the switching operation to a present duty of a power conversion device according to a current sign of the alternating current.
